(19) United States
(12) Patent Application Publication
(10) Pub. No.: US 2002/0011519 A1
(43) Pub. Date: Jan. 31, 2002

(54) System and method for consumer identification using optical and electronic means

(76) Inventor: John R. Shults III, Hurley, NY (US)

Correspondence Address: Christopher E. Chalsen, Esq., Milbank, Tweed, Hadley & McCloy LLP, 1 Chase Manhattan Plaza, New York, NY, 10005-1413, US

(21) Appl. No.: 09/848,094

(22) Filed: May 3, 2001

Related U.S. Application Data
(60) Provisional application No. 60/202,012, filed on May 4, 2000.

(51) Int. Cl. G06F 17/60

(52) U.S. Cl. 235/462.01; 705/16; 340/5.8; 340/10.1

(57) ABSTRACT

An apparatus, system and method whereby a single apparatus, with both electronic identity and optical identity is used to identify a customer or user. The electronic identity is provided by a Radio Frequency Identification (RFID) circuit in the apparatus, while the optical identity is provided by a 1D or 2D barcode affixed to the apparatus. When the apparatus is scanned at a point-of-sale system with an RFID or barcode reader, the appropriate identity is provided to the point-of-sale system, thereby allowing a customer to link the transaction with a customer account.

This application claims priority to U.S. Provisional Patent Application Ser. No. 60/202,012, entitled SYSTEM AND METHOD FOR CONSUMER IDENTIFICATION USING OPTICAL AND ELECTRONIC MEANS, filed on May 4, 2000, the disclosure of which is incorporated herein by reference.

### BACKGROUND OF THE INVENTION

1. Field of the Invention

The invention relates generally to the field of identification apparatus and systems, and more particularly to apparatus and systems using electronic identification and optical identification.

2. Background Information

Bar-code systems are known and used to identify products, and a number of point-of-sale systems are fielded to scan those bar-codes and match the code with price and inventory systems. Some of those point-of-sale systems are also able to read barcodes that are used to identify particular customers, such as for coupon redemption programs and preferred shopper discounts. These systems can be generally considered as optical identification systems.

There are also separate types of point-of-sale systems that employ electronic identification. In particular, there are systems such as EZ-PASS for electronic collection of tolls, and there is the MOBIL SPEEDPASS system for electronic payment of fuel purchases.

There is a need for an apparatus and system than can combine the features of these different systems and allow a customer or user to have transactions on different systems posted to a single account.

Citation of the foregoing is not to be construed as an admission that any of such is prior art relative to the present invention.

### SUMMARY OF THE INVENTION

In one aspect, the invention provides an identification apparatus comprising an electronic circuit producing an electronic signal to electronically identify the apparatus; and an optically coded region to optically identify the apparatus, wherein there is a relationship between the electronic identity and the optically coded identity. The electronic circuit may include a radio-frequency circuit or transponder circuit. The optically coded region may include a bar-code of a number of different types. In one aspect, the electronic identity and optical identity are the same. In another aspect, the electronic identity and optical identity are unique for each apparatus. In another aspect, the apparatus is a portable cellular telephone or a personal digital assistant.

In one aspect, the invention is a system comprising a scanner to identify an identification apparatus; a database including a list of users; and a processor communicating with the scanner and the database to correlate the identity of the apparatus with a particular user from the list of users, wherein the identification apparatus includes both an electronic identity and an optical identity. In one aspect, the scanner is a laser transmitter and receiver to read the optical identification code. In one aspect, the scanner is a radio-frequency scanner to read the electronic identification code.

In one aspect a method of the invention comprises scanning the apparatus with an electronic signal or an optical signal to identify the apparatus as having an electronic identity or an optical identity respectively; comparing the electronic identity or the optical identity with a list of users in a user database; and identifying a particular user based on the comparison, wherein the identification apparatus includes both an electronic identity and an optical identity.

In one aspect a method of the invention comprises presenting a combined radio-frequency identification and bar-code identification apparatus to a scanner, the scanner producing an electronic signal or an optical signal to generate a respective electronic identity or an optical identity of the apparatus; and receiving an indication of the user identity based on a comparison between a list of users in a user database and the electronic identity or the optical identity.

The foregoing specific objects and advantages of the invention are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWING

The foregoing features and other aspects of the invention are explained in the following description taken in conjunction with the accompanying figures wherein:

FIG. 1 illustrates an embodiment of one aspect of an apparatus according to the instant invention;

FIG. 2 illustrates an embodiment of one aspect of an apparatus according to the instant invention;

FIG. 3 illustrates an embodiment of one aspect of a system according to the instant invention;

FIG. 4 illustrates an embodiment of one aspect of data structures in a system according to the instant invention;

FIG. 5 illustrates an embodiment of one aspect of a system according to the instant invention; and

FIG. 6 illustrates an embodiment of one aspect of data structures in a system according to the instant invention; and

FIG. 7 illustrates an example of the PDF417 data format.

It is understood that the drawings are for illustration only and are not limiting.

### DETAILED DESCRIPTION OF THE INVENTION

In one aspect, the instant invention provides users or customers with enhanced flexibility and features in purchase transactions, while providing additional functionality in the use of existing point-of-sale equipment.

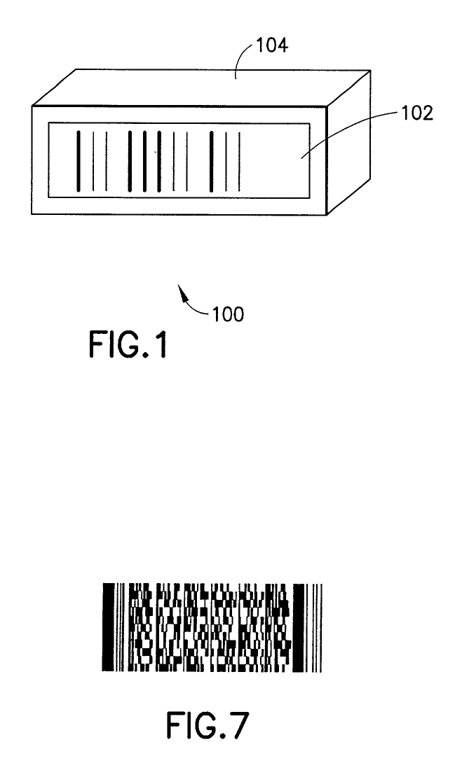

Referring to FIG. 1, an embodiment of an apparatus 100 of the instant invention is a hand-held apparatus incorporating both electronic identity and optical identity. The optical identity is provided by an optically coded region 102 on the apparatus, such as a bar-code. The electronic identity is provided by a radio-frequency electronic transponder 104. The hand-held or portable aspect of apparatus 100 is particularly advantageous when it is used for purchasing or other types of financial transactions. Features of these elements and examples of their use are provided below.

Optical Identity

In one embodiment, optically coded region 102 of apparatus 100 includes an optically readable bar-code that is coded according to the UCC/EAN-128 standard, with extended code format 1, 2, 3 or 4 being preferred formats. The UCC/EAN-128 standard and a description of the various formats is available from the Uniform Code Council, Inc., 8163 Old Yankee Rd., Suite J, Dayton, Ohio 45458. A technical description of the UCC/EAN-128 is found in the USS-128 Uniform Symbology Specifications Code 128, available from the Automatic Identification Manufacturers (AIM USA) in Pittsburgh, Pa.

Though other optically readable codes are available, use of the UCC/EAN-128 standard is advantageous as it allows flexibility in the coding of customer identification information and also includes a larger number of data bits in the data fields than other code types. Additionally, most point of sale systems with the ability to read Uniform Product Codes (UPC) also have the ability to read the UCC/EAN-128 standard, with some modification of the software. Use of a recognized code standard than can be integrated with existing point-of-sale systems is helpful in rapidly fielding apparatus 100 and integrating the added capability into existing commercial systems.

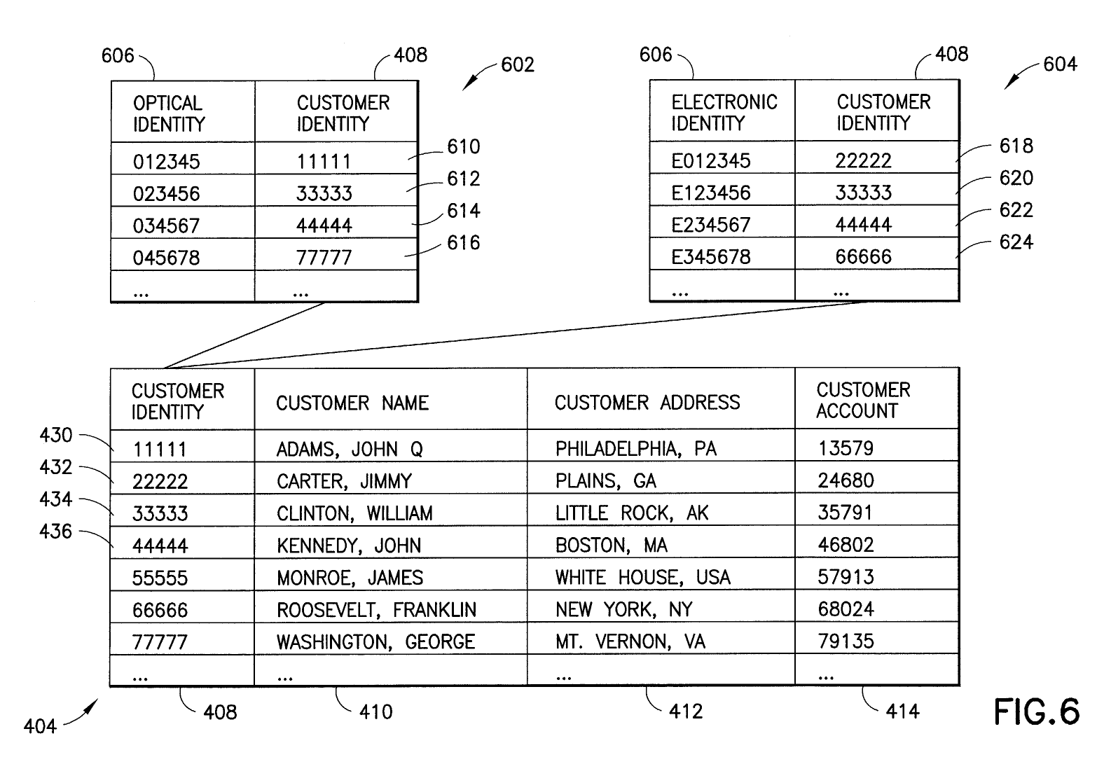

However, there is no requirement that optically coded region 102 is a traditional linear bar-code such as the UCC/EAN-128. There are also optically readable codes that are characterized as two-dimensional codes, which have a significantly greater data capability and also have the ability to include encryption within the code. Examples of these two-dimensional codes are the code used on the Uniformed Services Identification Cards, as well as electronic postage provided by Stamps.com. One particular format that has gained acceptance is the PDF-417. An example of this type of a PDF-417 two-dimensional code is provided in FIG. 7. The PDF-417 code, initially developed by Symbol Technologies in Holtsville, N.Y. is a particularly useful two-dimensional code for optically coded region 102 of apparatus 100. The PDF-417 code requires a 2-D scanner, or a standard CCD or laser scanner and special decoding software. Because of the two-dimensional nature of the code, a wand scanner does not generally work. Some point-of-sale systems are presently able to read these types of three-dimensional codes, and because minimizing the need to modify point-of-sale systems is one advantage of the instant invention, use of a format or standard optically coded region that is widely adopted and readable by point-of-sale systems is preferred for apparatus 100.

Electronic Identity

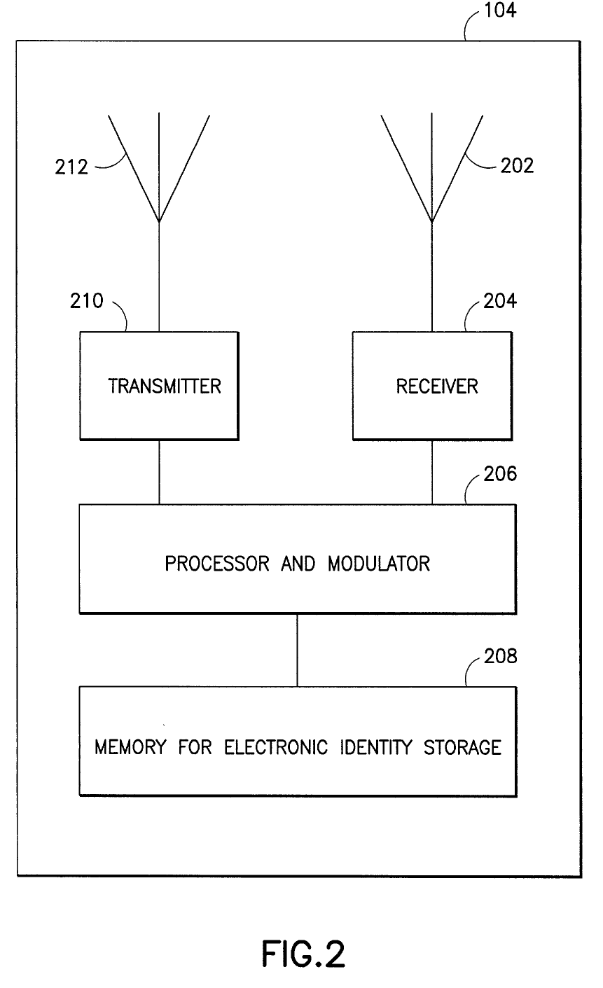

Referring to FIG. 2, an example of the electronic circuit providing the electronic identity of the instant is provided by a radio-frequency identification (RFID) circuit 104. The RFID circuit includes receive antenna 202, which receives an appropriately coded interrogation signal from an electronic scanner at a point of sale system. The received signal is processed by receiver 204, where it is demodulated from the carrier frequency and the resulting signal is forwarded to processor and modulator 206. Processor and modulator 206 determine that the interrogation signal is valid and intended for the RFID unit and then retrieves the electronic identity of apparatus 100 from memory storage 208. This electronic identity information is modulated with a transmission signal by processor and modulator 206 and then up-converted or mixed with a transmission carrier frequency by transmitter 210 before it is transmitted by apparatus 100 over antenna 212.

These components and step are performed by a number of different types of systems operating at various transmission frequencies. In one embodiment, electronic circuit 104 is a Texas Instruments TIRIS system. In other embodiments, electronic circuit 104 is a TAGIT from Texas Instruments, a ROADCHECK system from Mark IV Inc., an ASSET ID system from HID Corp., a SUPERTAG system from BTG PLC, a contactless smart card (e.g., the MIFARE certification from Phillips Semiconductor), or a BLUETOOTH compliant device. It is also possible that electronic circuit 104 is an analog or digital cellular telephone, and that the electronic identity stored in memory 208 is the Electronic Identification Number (EIN) of the cellular telephone. Similarly, it is also possible the electronic circuit 104 is a personal digital assistant, with radio frequency or infrared transmission/reception capabilities.

The operating radio frequencies of the variously described examples are generally between 10 and 20 KHz, or between 100 and 200 KHz, or approximately 13.56 MHz, or between 850 and 950 MHz, or between 2.2 and 2.6 GHz, or between 5 and 6 GHz. The infrared operating frequencies are those established according to, for example, the IrDa standard or format.

A primary attribute of electronic circuit 104 is that apparatus 100 responds to an interrogation or activation signal with a return signal and that an electronic identification is included with the response.

Electronic and Optical Identification

Typically, the identification (whether it is the electronic identification provided by electronic circuit 104, or the optical identification provided by optically coded region 102) is unique to apparatus 100, meaning that each apparatus has a unique identification. Alternatively, where a family or group of users have common account information, it may be desirable to have multiple apparatus for that group with the same identification, but different identification for apparatus of different groups. Similarly, it may be appropriate to have unique electronic identification and optical identification for one apparatus, or it may be appropriate to have the electronic and optical identification of the apparatus the same.

System of the Inventions and Databases

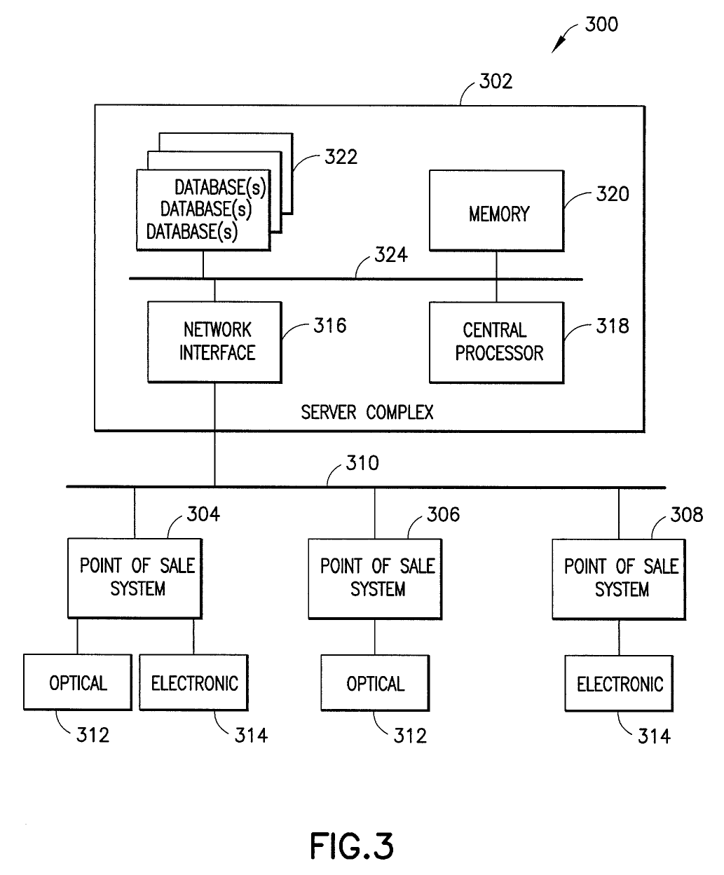

Apparatus 100 of the present invention is intended to be used with existing point-of-sale systems to the maximum extent possible, without requiring significant modifications to the point-of-sale system. To this end, where point-of-sale systems already have optical scanning capabilities (such as for check-out or product sales) it is desirable to use those existing systems. Referring to FIG. 3, an embodiment of system 300 of the present invention includes a central server complex 302. Server complex 302 is electronically connected by network 310 to various point-of-sale systems 304, 306, 308. Point-of-sale systems 306 variously include optical scanner equipment 312 and electronic scanner equipment 314. Some point-of-sale systems 306 rely primarily or solely on optical scanners, while others 308 rely primarily or solely on electronic scanners. Some point-of-sale systems 304 will include both optical 312 and electronic 314 scanners.

As examples, where customers or users traditionally have close contact with the point-of-sale system (such as a supermarket) an optical scanner may be appropriate. Alternatively, where customers or users traditionally have distant contact with the point-of-sale system (such as a gasoline station) an electronic scanner may be appropriate. Finally, where customers or users have both close and distant contact with the point of sale system (such as a fast food facility with counter service and drive-through service), both types of scanner may be appropriate.

Server complex 302 includes a network interface 316 for connection between network 324, which is internal to complex 302, and network 310, which is external to complex 302. As such, where network 310 is a LAN, network interface 316 may be an Ethernet type of connector for connection to the LAN. Where network 310 is a WAN, interface 316 may be a Frame Relay, ATM or similar connection to the WAN. The primary factor is that the interface provides appropriate connection between network 324 and network 310. Also connected to network 324 are central processor 318, memory 320 and database(s) 322. Central processor 318 and memory 320 are any of the known types of computers and memory, such as an Intel Pentium III computer. Database(s) 322 are also of the known types of database, such as SQL or Excel that are typically stored on non-volatile media connected to the server. In a preferred embodiment, database(s) 322 are relational databases.

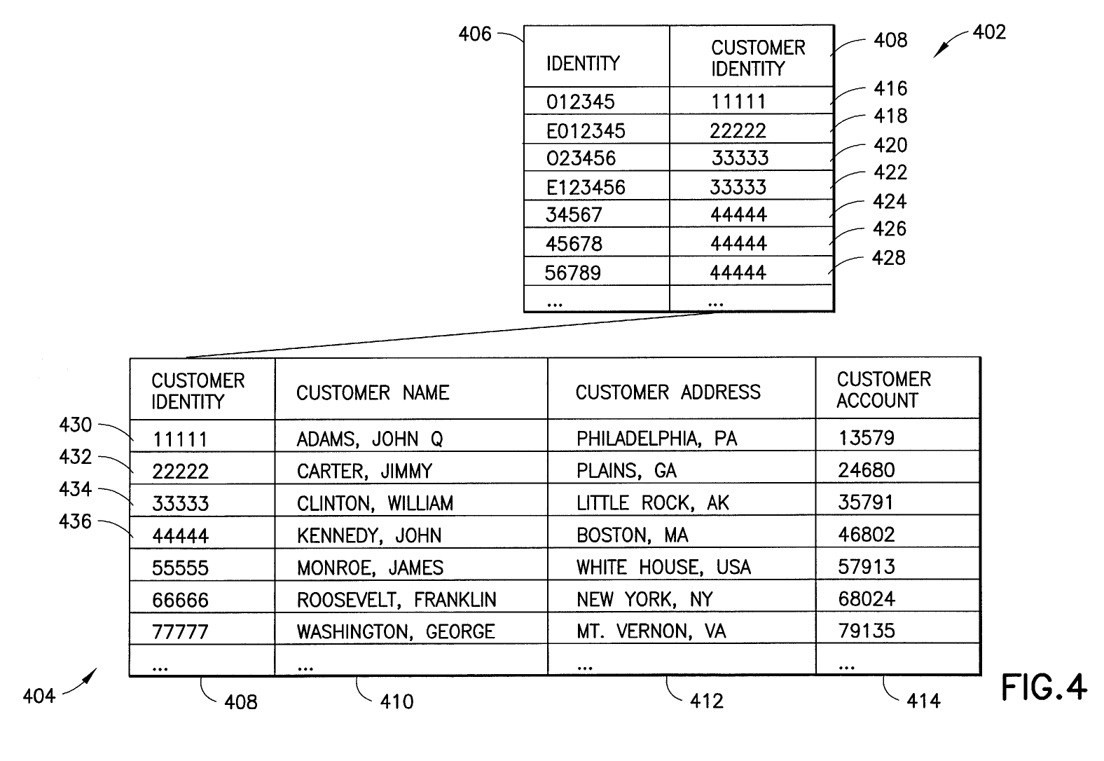

Referring to FIG. 4, an embodiment of the relational database structure of database(s) 322 includes an Apparatus Identity—Customer Identity list 402 and a Customer information and account list 404. List 402 includes apparatus identity, both electronic and optical 406, as well as customer identity 408. In list 402, the Apparatus Identity field 406 is unique, though there may be a single customer identity relating to a multiple apparatus identities. As examples, records 416 and 418 each have a single customer identity for a single apparatus identity. Records 420 and 422 have a single customer identity with relates to different apparatus identities. In particular, record 420 relates to a optical identity, while record 422 relates to an electronic identity. In this manner, a customer may subscribe to both the electronic and optical services and have different respective identities, but the identities both relate to the single customer.

Similarly, records 424, 426 and 428 all relate to the same customer identity, but have different apparatus identities. In this case, there is no distinction between electronic or optical identity, the same identity being used for both scan systems. This structure allows members of a family or group to have different apparatus with different identities, but each apparatus is linked to the same customer account. This would be useful for a family or business where a common account is used for transactions, but each individual needs to have their own apparatus.

List 404 includes the customer identity field 408, which is the field linking list 402 and 404. List 404 includes other customer information, such as address 412 and account information 414.

As previously stated, database(s) 322 are maintained in server complex 302 and include lists 402 and 404. In this manner, when a customer presents apparatus 100 at scanner 312 or 314, the point-of-sale system 304, 306, 308 determines the identity (electronic or optical) and sends that identity information to server complex 302 where list 402 and 404 of database 322 are used to identify the particular customer and customer account associated with that apparatus.

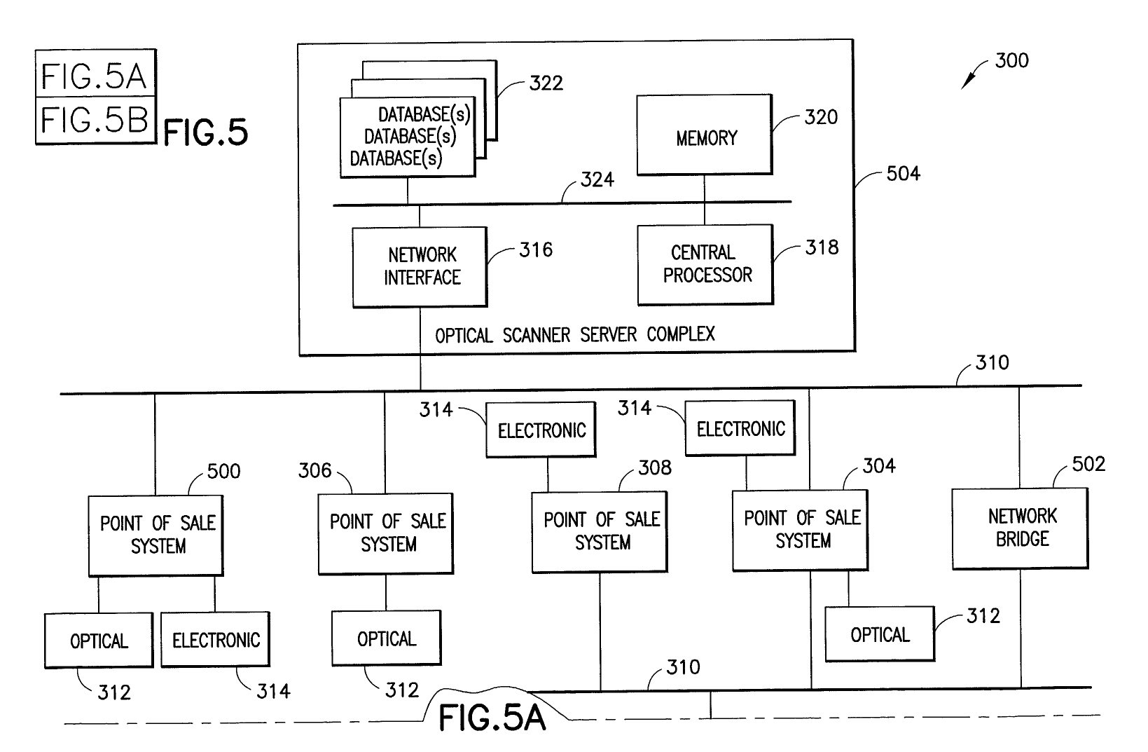

In the embodiment of FIG. 3, system 300 includes a single type of server complex 302, which supports both electronic and optical identities of apparatus 100. Referring to FIG. 5, another embodiment of system 300 includes a distinct server complex for optical identities 504 and a distinct server complex for electronic identities 506. In this manner, those types of transaction or business that are already supporting either electronic or optical scanning can maintain their own systems and data structures. Some point-of-sale systems 306, 308 will only have optical or electronic scanning capability respectively. Other point-of-sale systems 304 will have both electronic and optical types of scanning capabilities. An advantage of the embodiment of FIG. 5 is that some individual point-of-sale systems 306, 308 require little or no modification, and supporting networks 504 and 506 also require little or no modification. However, while the embodiment of FIG. 5 reduces the need to modify existing systems, if point-of-sale system 500 includes both optical 312 and electronic 314 scan capability, but is only served by optical identification server complex 504 there is a need for some form of interconnect between server complex 504 and 506. This interconnect is provided by network bridge 502. Bridge 502 acts as a surrogate or proxy by passing information between the different servers and different and data structures. As such, electronic scan information from point-of-sale system 500 is scanned by electronic scanner 314. However, server 504 does not have the ability to match the electronic identity with a customer identity, because database(s) 322 only contain optical identity to customer lists. Accordingly, the data is forwarded from server 504 through bridge 502, where it is re-formatted to represent the same structure as data from an electronic point of sale system 308. Bridge 502 performs the necessary reformat and translation to pass the data between servers to allow the servers to operate with minimal modification.

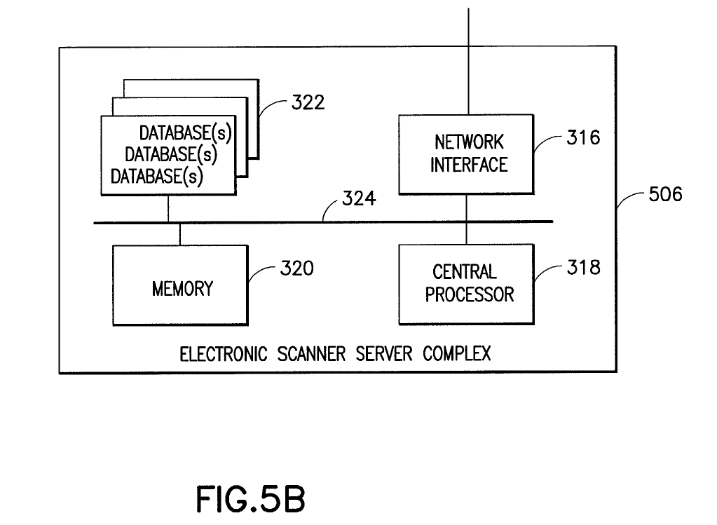

When system 300 is configured as illustrated in FIG. 5, the supporting databases will have a different format. Accordingly, referring to FIG. 6, database(s) 322 of optical server 504 will include list 602, with optical identity 606 and customer identity 408 fields. Similarly, database(s) 322 of electronic server 506 will include list 604, with electronic identity 608 and customer identity 408. List 404, or parts of list 404 will be maintained in both optical server 504 and electronic server 506. As such, a customer or user may present apparatus 100 at any type of point-of-sale system and their transaction will be handled according to the type of supporting server and network.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

I claim:

1. An identification apparatus comprising:
an electronic circuit producing an electronic signal to electronically identify the apparatus; and
an optically coded region to optically identify the apparatus, wherein there is a relationship between the electronic identity and the optically coded identity.

2. An apparatus according to claim 1, wherein the electronic circuit includes a radio-frequency circuit.

3. An apparatus according to claim 1, wherein the electronic circuit includes a radio-frequency transponder circuit.

4. An apparatus according to claim 1, wherein the electronic circuit includes an infrared transmission circuit.

5. An apparatus according to claim 1, wherein the optically coded region includes a bar-code.

6. An apparatus according to claim 1, wherein the optically coded region includes a Uniform Product Code coupon code.

7. An apparatus according to claim 1, wherein the optically coded region includes a coupon extended code corresponding to the specification of UCC/EAN-128.

8. An apparatus according to claim 1, wherein the relationship between the electronic identity and the optical identity is the same identity.

9. An apparatus according to claim 1, wherein the electronic identity or optical identity is unique for each apparatus.

10. An apparatus according to claim 1, wherein the electronic identity or optical identity is the same within groups of two or more apparatus but unique between the groups of apparatus.

11. An apparatus according to claim 1, wherein the apparatus is a portable cellular telephone.

12. An apparatus according to claim 11, wherein the electronic identity is the Electronic Identification Number of the cellular telephone.

13. An apparatus according to claim 1, wherein the apparatus is a personal digital assistant with radio-frequency capability.

14. A hand-held combined radio-frequency identification and bar-code identification apparatus comprising:
a radio-frequency transponder producing a radio-frequency signal to electronically identify the apparatus; and
a bar-coded region to optically identify the apparatus, wherein the electronic identity and the optical identity are both related to a user of the apparatus and an account of the user.

15. An apparatus according to claim 14, wherein the bar-coded region includes a code selected from the group including Uniform Product Code coupon code, and coupon extended code corresponding to the specification of UCC/EAN-128.

16. An apparatus according to claim 14, wherein the radio-frequency signal is between 10 and 20 KHz or between 100 and 200 KHz or approximately 13.56 MHz or between 850 and 950 MHz or between 2.2 and 2.6 GHz or between 5 and 6 GHz.

17. An apparatus according to claim 14, wherein the transponder produces the radio-frequency signal in response to a radio signal between 10 and 20 KHz or between 100 and 200 KHz or approximately 13.56 MHz or between 850 and 950 MHz or between 2.2 and 2.6 GHz or between 5 and 6 GHz.

18. An apparatus according to claim 14, wherein the relationship between the electronic identity and the optical identity is the same identity.

19. An apparatus according to claim 14, wherein the electronic identity or the optical identity is unique for each apparatus.

20. An apparatus according to claim 14, wherein the electronic identity or optical identity is the same within groups of two or more apparatus but unique between the groups of apparatus.

21. A system comprising:
a scanner to identify an identification apparatus;
a database including a list of users; and
a processor communicating with the scanner and the database to correlate the identity of the apparatus with a particular user from the list of users, wherein the identification apparatus includes both an electronic identity and an optical identity.

22. A system according to claim 21, wherein the scanner includes a circuit to identify the identification apparatus using an electronic signal from the identification apparatus.

23. A system according to claim 21, wherein the scanner further comprises:
a radio-frequency transmitter; and
a radio-frequency receiver, the transmitter and receiver to interrogate the identification apparatus.

24. A system according to claim 21, wherein the scanner includes an optical detector to identify the identification apparatus using an optical signal from the identification apparatus.

25. A system according to claim 21, wherein the scanner further comprises:
a laser transmitter; and
a laser receiver, the transmitter and receiver to read an optical identification code on the identification apparatus.

26. A system comprising:
a radio-frequency scanner or a laser scanner to identify an identification apparatus;
a user database including a list of users;
a computer processor communicating with the radio-frequency scanner or the laser scanner and the user database to correlate the identity of the identification apparatus with a particular user from the list of users, wherein the identification apparatus includes both a radio-frequency transponder and a optical bar code region responsive to the radio-frequency scanner or the laser scanner respectively.

27. A system according to claim 26, wherein the laser scanner identifies barcodes selected from the group including Uniform Product Code coupon code, and coupon extended code corresponding to the specification of UCC/EAN-128.

28. A system according to claim 26, wherein the radio-frequency scanner produces a radio signal between 10 and 20 KHz or between 100 and 200 KHz or approximately 13.56 MHz or between 850 and 950 MHz or between 2.2 and 2.6 GHz or between 5 and 6 GHz.

29. A system according to claim 26, wherein the radio-frequency scanner receives a radio signal between 10 and 20 KHz or between 100 and 200 KHz or approximately 13.56 MHz or between 850 and 950 MHz or between 2.2 and 2.6 GHz or between 5 and 6 GHz.

30. A method for identifying a user with an identification apparatus comprising:
scanning the apparatus with an electronic signal or an optical signal to identify the apparatus as having an electronic identity or an optical identity respectively;
comparing the electronic identity or the optical identity with a list of users in a user database; and
identifying a particular user based on the comparison, wherein the identification apparatus includes both an electronic identity and an optical identity.

31. A method for identifying a user comprising:
presenting a combined radio-frequency identification and bar-code identification apparatus to a scanner, the scanner producing an electronic signal or an optical signal to generate a respective electronic identity or an optical identity of the apparatus; and
receiving an indication of the user identity based on a comparison between a list of users in a user database and the electronic identity or the optical identity.
